(19) United States
(12) Patent Application Publication
(10) Pub. No.: US 2009/0259646 A1
(43) Pub. Date: Oct. 15, 2009

(54) Method for Calculating Score for Search Query

(75) Inventors: Sumio Fujita, Tokyo (JP); Georges Dupret, Santiago (CL)

Correspondence Address: BAKER BOTTS L.L.P., 2001 ROSS AVENUE, 6TH FLOOR, DALLAS, TX, 75201, US

(73) Assignee: Yahoo!, Inc., Sunnyvale, CA (US)

(21) Appl. No.: 12/099,980

(22) Filed: Apr. 9, 2008

(51) Int. Cl. G06F 17/30

(52) U.S. Cl. 707/5; 707/E17.108

(57) ABSTRACT

A method and system for automatically calculating, regarding an input search query, a score for evaluating a new query or URL which is a candidate for recommendation information according to a user's search intention. To this end, a recommendation server 10 extracts recommended queries or URLs regarding a certain query, and configures a graph structure in which a plurality of queries are sequentially connected via URLs, based on historical data of URLs searched and browsed by the user in the past. The recommendation server 10 then calculates a score for indicating a degree of popularity of each query, by analyzing a relationship between input and output of edges, i.e. a linking relationship of URLs, in which each query is a node in this graph structure.

### TECHNICAL FIELD

The present disclosure relates to a method and apparatus for calculating a score for a search query.

### BACKGROUND

Conventionally in the search services on the Web, a user inputs keywords as a query, and searches Web pages including the keywords. A method is employed in which URLs of the Web pages extracted as a result of the search are displayed as a list on a display screen. In this case, ranking of the search result is performed in many cases in order to efficiently lead the user to desired Web pages, based upon a predetermined index indicating the degree of popularity or the search frequency of the Web pages.

Moreover, another method has also been proposed in which past browsing history of the user including other users is utilized in order to lead the user to Web pages, which are desired by the user, or which are more necessary for the user. For example, Japanese Unexamined Patent Application Publication No. 2004-326537 describes that a history of operations to Web pages by a user group as well as a history of purchasing products at EC (Electronic Commerce) sites are stored in a server, and when a request is made by the user designating a product name and the like, Web pages, which have been browsed by users of the user group who have purchased the product, are extracted.

### SUMMARY

However, it makes no difference by the method described in Japanese Unexamined Patent Application Publication No. 2004-326537 in a sense that Web pages, which correspond to the keywords input by the user, are searched. Accordingly, unless appropriate keywords are input, it is difficult to reach Web pages which are desired by the user. That is to say, there has been a problem that a query has to be accurate because the reliability of a search result largely depends on the query input by the user.

In order to reach Web pages desired by the user, it is necessary to newly input an efficient query. It is preferable if this is provided as recommendation information. Thus, an object of the present invention is to provide a method for automatically calculating, for a search query that is input, a score for evaluating a new query or URL which is a candidate of recommendation information according to the user's search intention.

### Means for Solving the Problems

The present invention provides the following solving means.

In a first aspect of the present invention, a method is provided for calculating a score for a query that is input by a user to a search engine, the method including the steps of: storing historical data including a query log and click-through data, the query log including a keyword as the query, a URL as a search result by the search engine, and ranking of the URL, and the click-through data being related to the URL; analyzing the historical data for generating a graph structure of a query definition, in which the query is a node and a plurality of nodes are connected by URLs that are common to the plurality of nodes, the URLs being browsed based on the search result corresponding to the query of the node; extracting, from the graph structure, combinations of recommendation source queries and recommended queries which are connected by URLs; calculating a score for the combinations extracted in the extracting step, based on the click-through data and ranking data; and associating at least one combination extracted in the extracting step with one recommendation source query.

With this configuration, the server performing the method stores historical data including a query log and click-through data (click count of a URL, a ratio of the click count to the display count of the URL, etc.), in which the query log includes a keyword as the query, a URL as a search result by the search engine, and ranking of the URL, and the click-through data is related to the URL. The server analyzes the historical data in order to generate a graph structure of a query definition, in which the query is a node and a plurality of nodes are connected by URLs that are common to the plurality of nodes, and the URLs are browsed based on the search result corresponding to the query of the node. The server extracts, from the graph structure, combinations of recommendation source queries and recommended queries which are connected by URLs. The server calculates a score for the combinations extracted in the extracting step, based on the click-through data and ranking data. The server associates at least one combination extracted in the extracting step with one recommendation source query.

This enables the server to generate a graph structure, in which the query is a node and a plurality of nodes are connected by URLs that are common to the plurality of nodes, based on the historical data including the query log and the click-through data. A score based on the click-through data and ranking data is calculated for the combination of the recommendation source query and the recommended query, the combination being extracted from the graph structure. The combination is associated with one recommendation source query. This enables calculation and evaluation of the score of each recommended query in relation to the one recommendation source query.

In a second aspect of the method as described in the first aspect of the present invention, the method further includes the steps of: identifying the recommendation source query by receiving an input query; and outputting, in response to receiving the input query, at least one recommendation source query from combinations extracted by associating with the input query.

With this configuration, the server performing the method identifies the recommendation source query by receiving an input query, and outputs, in response to receiving the input query, at least one recommendation source query from combinations extracted by association with the input query.

This enables the server to output, in response to receiving the input query, at least one recommendation source query, in which the input query is a recommendation source query. Accordingly, it is possible to present a recommendation source query which is different from an input query, in response to the score calculated based on the historical data.

In a third aspect of the present invention, a method is provided for calculating a score for a query that is input by a user to a search engine in a server that is connected, via a network, to a terminal device and a search server provided with the predetermined search engine, the method comprising the steps of: storing, as historical data, a query input to the search engine from the terminal device, a URL browsed based on a search result of the search engine in response to the input of the query, and ranking of the URL browsed in the search result, so as to be associated with one another; extracting, based on the stored historical data, combinations including recommendation source queries, URLs and recommended queries, wherein, among a plurality of queries associated with the same URL, each respective query having an evaluation value high in ranking is included in the recommended queries, and wherein queries other than the recommended queries are the recommendation source queries; and calculating a score for each query input by the user, by analyzing a relationship between input and output of edges in a graph structure which is configured by a set of the extracted combinations, and in which a plurality of queries are connected via URLs, wherein each query is a node of the graph structure.

With this configuration, the server performing the method stores queries input to the search engine from the terminal device, URLs browsed based on a search result of the search engine in response to the input of the query, and ranking of the URLs browsed in the search result, so as to be associated with one another. Based on the stored historical data, combinations are extracted including recommendation source queries, URLs and recommended queries, in which, among a plurality of queries associated with the same URL, queries having evaluation values high in ranking are the recommended queries, and in which queries other than the recommended queries are the recommendation source queries. A score for each query input by the user is calculated, by analyzing a relationship between input and output of edges in a graph structure which is configured by a set of the combinations, and in which a plurality of queries are connected via URLs, and in which each query is a node of the graph structure.

This enables the server to extract recommended queries and URLs regarding a certain query, and configure a graph structure in which a plurality of queries are connected via URLs, based on the historical data (click log) of the URLs searched and browsed by the user in the past. By analyzing a relationship between input and output of edges in which each query is a node in the graph structure (i.e. a linking relationship of URLs), a score for indicating a degree of popularity of each query is calculated, thereby making it possible to calculate a score according to the user's search intention, in relation to a click log that is dynamically accumulated data.

That is, the server is able to apply an analysis technique used for static hyperlink structures on the Internet, based on the relationship between input and output of edges regarding each node in the graph structure, to a click log that is dynamic data.

It should be noted that the aforementioned score can be calculated by applying existing techniques such as PageRank (registered trademark), HITS and SALSA (see, for example, “Mining the Web-Discovering Knowledge from Hypertext Data” Soumen Chakrabarti, Morgan Kaufmann Publishers, 2003). Though these techniques are for analyzing hyperlink structures on the Internet, the aforementioned graph structure is also a structure in which queries are linked with URLs, and therefore is applicable.

Moreover, plural types of scores may be calculated by employing these plural analysis techniques. Furthermore, these plural types of scores may be integrated by, for example, a method for obtaining a weighted average and doing the like to obtain another evaluation value.

In a fourth aspect of the present invention, a method is provided for calculating a score for a URL associated with a query that is input by a user to a search engine in a server that is connected, via a network, to a terminal device and a search server provided with the predetermined search engine, the method including the steps of: storing, as historical data, a query input to the search engine from the terminal device, a URL browsed based on a search result of the search engine in response to the input of the query, and ranking of the URL browsed in the search result, so as to be associated with one another; extracting, based on the stored historical data, combinations including recommendation source queries, URLs and recommended queries, wherein, among a plurality of queries associated with the same URL, queries having evaluation values high in ranking are the recommended queries, and wherein queries other than the recommended queries are the recommendation source queries; and calculating a score for each of the URLs, by analyzing a relationship between input and output of edges in a graph structure which is configured by a set of the extracted combinations, and in which a plurality of URLs are connected via queries, wherein each URL is a node of the graph structure.

With this configuration, the server performing the method extracts the combinations including the recommendation source queries, the URLs and the recommended queries, as in the case with the third aspect of the present invention. A score for each of the URLs is calculated by analyzing a relationship between input and output of edges in a graph structure, in which each URL is a node of the graph structure, and in which a plurality of URLs are connected via queries, and which is configured with a set of the combinations.

This enables the server to extract recommended queries and URLs regarding a certain query, and configure a graph structure in which a plurality of URLs are connected via queries, based on the historical data (click log) of the URLs searched and browsed by the user in the past. By analyzing a relationship between input and output of edges in which each URL is a node in the graph structure (i.e. a searching relationship of queries), a score for indicating a degree of popularity of each URL is calculated, thereby making it possible to calculate a score according to the user's search intention, in relation to a click log that is dynamically accumulated data.

That is, the server is able to apply an analysis technique used for static hyperlink structures on the Internet, based on the relationship between input and output of edges regarding each node in the graph structure, to a click log that is dynamic data.

It should be noted that the aforementioned score can be calculated by applying existing techniques as is the case with the third aspect of the present invention. Moreover, plural types of scores may be calculated by employing plural analysis techniques. Furthermore, these plural types of scores may be integrated by, for example, a method for obtaining a weighted average and doing the like to obtain another evaluation value.

In a fifth aspect of the method as described in the third aspect of the present invention, the method further comprises a first transmitting step, wherein, in response to a newly input query from the terminal device, a query associated with the newly input query is extracted as recommendation information based on the graph structure and the score, and is transmitted to the terminal device.

This configuration enables the server performing the method to extract a query as recommendation information based on the graph structure and the calculated score, and to present it to the user.

Thus, a new query is recommended based on the calculated score, thereby making it possible to efficiently recommend a query with a high degree of popularity in searches performed in the past, therefore it is expected that the user can easily reach a desired Web page.

In this case, as for a query output as recommendation information, a query in a lower position in the graph structure, i.e. a recommended query regarding a recommendation source query may be extracted as a candidate, but it is not limited thereto. For example, a query in a higher position, i.e. a recommendation source query regarding a recommended query may be extracted as a candidate. Moreover, by tracking the graph structure regardless of higher or lower positions, a query in the vicinity of the query may be prioritized using an evaluation value according to its distance. Furthermore, a query in the vicinity of the query in the lower position may be output as a subordinate concept, and a query in the vicinity of the query in the higher position may be output as a superordinate concept.

Thus, there is a possibility that the server can provide efficient recommendation information, since an evaluation method is set according to each situation.

In a sixth aspect of the method as described in the fourth aspect of the present invention, the method further comprises a first transmitting step, wherein, in response to a newly input query from the terminal device, a URL associated with the newly input query is extracted as recommendation information based on the graph structure and the score, and is transmitted to the terminal device.

This configuration enables the server performing the method to extract a query as recommendation information based on the graph structure and the calculated score, and to present it to the user.

Thus, a new query is recommended based on the calculated score, thereby making it possible to efficiently recommend a query with a high degree of popularity in searches performed in the past, therefore it is expected that the user can easily reach a desired Web page.

In this case, as for a URL output as recommendation information, as is the case with the fifth aspect of the present invention, a URL in a lower position in the graph structure, i.e. a URL positioned between a recommended query and a recommendation source query may be extracted as a candidate, but it is not limited thereto. For example, a URL in a higher position, i.e. a URL positioned between a recommendation source query and a recommended query may be extracted as a candidate. Moreover, by tracking the graph structure regardless of higher or lower positions, a URL in the vicinity of the URL may be prioritized using an evaluation value according to its distance. Furthermore, a URL in the vicinity of the URL in the lower position may be output as a subordinate concept, and a URL in the vicinity of the URL in the higher position may be output as a superordinate concept.

Thus, there is a possibility that the server can provide efficient recommendation information, since an evaluation method is set according to each situation.

In a seventh aspect of the method as described in the fifth aspect of the present invention, the first transmitting step extracts queries having scores within a predetermined range of values in relation to the newly input query, the extracted queries being high in ranking.

This configuration enables the server performing the method to preferentially recommend queries having scores correspond or approximate to the score of the input query. Here, the queries having scores correspond or approximate to the score of the input query are synonymous in many cases, so there is a possibility that queries can be efficiently presented which make it possible to obtain similar information.

In an eighth aspect of the method as described in any one of the fifth to seventh aspects of the present invention, the first transmitting step groups and extracts, from the recommendation information, recommendation information having a score within a predetermined range of values.

This enables the server performing the method to group queries having scores correspond or approximate to one another. For example, by displaying only a representative of the synonyms or by displaying a group of the synonyms as separated from other groups, it is expected that the user can more easily grasp the recommendation information.

Moreover, the server is able to group URLs having scores correspond or approximate to one another. This makes it possible to display only representative URLs or a group of URLs separate from other groups, as for URLs indicated as different but referring to the same Web page, or URLs for Web pages with similar contents.

In a ninth aspect of the method as described in any one of the fifth to eighth aspects of the present invention, the first transmitting step calculates, based on the score, an evaluation value for each of the recommendation information in relation to the newly input query, and extracts recommendation information excluding recommendation information having an evaluation value below a predetermined value.

This configuration enables the server performing the method to evaluate a query or a URL to be a candidate of recommendation information, in relation to the newly input query. By excluding the recommendation information having a low evaluation value, there is a possibility that efficient recommendation information can be presented to the user.

In a tenth aspect of the method as described in any one of the fifth to ninth aspects of the present invention, the method further includes a second transmitting step of transmitting a search result of the search engine based on the newly input query in cases where the recommendation information is not extracted in the first transmitting step.

This configuration enables the server performing the method to present, with a conventional search technique, URLs associated with the input query in cases where there is no information to be recommended.

In an eleventh aspect of the method as described in any one of the fifth to tenth aspects of the present invention, the first transmitting step selects, from the graph structure, a query having a similarity to the newly input query exceeding a predetermined degree, and extracts the recommendation information with the selected query being a base point.

With this configuration, when extracting recommendation information, the server performing the method selects data which corresponds or approximates the input query from the prepared graph structure.

This enables the server to select, from the graph structure, not only a perfectly corresponding query, but also a partially corresponding query as well as a query which is estimated to be synonymous according to the similarity measured by an edit distance of character strings. Therefore, there is a possibility that slight differences in notations of queries input by the user are assimilated, and those queries can be efficiently processed as the same query.

In a twelfth aspect of the present invention an apparatus is provided for calculating a score for a query that is input by a user to a search engine, the apparatus being connected, via a network, to a terminal device and a search server provided with the predetermined search engine, the apparatus comprising: storing means for storing, as historical data, a query input to the search engine from the terminal device, a URL browsed based on a search result of the search engine in response to the input of the query, and ranking of the URL browsed in the search result, so as to be associated with one another; extracting means for extracting, based on the stored historical data, combinations including recommendation source queries, URLs and recommended queries, wherein, among a plurality of queries associated with the same URL, each respective query having an evaluation value high in ranking is included in the recommended queries, and wherein queries other than the recommended queries are the recommendation source queries; and calculating means for calculating a score for each query input by the user, by analyzing a relationship between input and output of edges in a graph structure which is configured by a set of the extracted combinations, and in which a plurality of queries are connected via URLs, wherein each query is a node of the graph structure.

With this configuration, by implementing the apparatus for calculating a score, effects similar to those of the third aspect of the present invention can be expected.

In a thirteenth aspect of the present invention an apparatus is provided for calculating a score for a URL associated with a query that is input by a user to a search engine, the apparatus being connected, via a network, to a terminal device and a search server provided with the predetermined search engine, the apparatus comprising: storing means for storing, as historical data, a query input to the search engine from the terminal device, a URL browsed based on a search result of the search engine in response to the input of the query, and ranking of the URL browsed in the search result, so as to be associated with one another; extracting means for extracting, based on the stored historical data, combinations including recommendation source queries, URLs and recommended queries, wherein, among a plurality of queries associated with the same URL, queries having evaluation values high in ranking are the recommended queries, and wherein queries other than the recommended queries are the recommendation source queries; and calculating means for calculating a score for each of the URLs, by analyzing a relationship between input and output of edges in a graph structure which is configured by a set of the extracted combinations, and in which a plurality of URLs are connected via queries, wherein each URL is a node of the graph structure.

With this configuration, by implementing the apparatus for calculating a score, effects similar to those of the fourth aspect of the present invention can be expected.

### Effects of the Invention

According to the present invention, it is possible to automatically calculate, regarding an input search query, a score for evaluating a new query or URL which is a candidate for recommendation information according to a user's search intention.

### DESCRIPTION OF THE DRAWINGS

FIG. 1 is a block diagram which shows a search system according to one example of a preferred embodiment of the present invention;

FIG. 2 is a block diagram which shows a functional configuration of a recommendation server 10 according to one example of the preferred embodiment of the present invention;

FIG. 3 is a diagram which shows a click data table according to one example of the preferred embodiment of the present invention;

FIG. 4 is a diagram which shows a query definition graph data table according to one example of the preferred embodiment of the present invention;

FIG. 5 is a diagram which shows a URL definition graph data table according to one example of the preferred embodiment of the present invention;

FIG. 6 is a diagram which shows a query definition graph structure according to one example of the preferred embodiment of the present invention;

FIG. 7 is a diagram which shows a URL definition graph structure according to one example of the preferred embodiment of the present invention;

FIG. 8 is a diagram which shows a query definition score table according to one example of the preferred embodiment of the present invention;

FIG. 9 is a diagram which shows a URL definition score table according to one example of the preferred embodiment of the present invention;

FIG. 10 is a flow chart of a process of creating graph data according to one example of the preferred embodiment of the present invention;

FIG. 11 is a diagram which shows a relationship between a recommended query and recommendation source queries according to one example of the preferred embodiment of the present invention;

FIG. 12 is a diagram which shows combinations extracted as graph data according to one example of the preferred embodiment of the present invention;

FIG. 13 is a flow chart which shows a process of creating score data according to one example of the preferred embodiment of the present invention;

FIG. 14 is a flow chart which shows a process of performing searches according to one example of the preferred embodiment of the present invention;

FIG. 15 is a diagram which shows a first example of a display screen on which recommendation data is displayed according to one example of the preferred embodiment of the present invention;

FIG. 16 is a diagram which shows a second example of a display screen on which recommendation data is displayed according to one example of the preferred embodiment of the present invention; and

FIG. 17 is a diagram which shows an example of a hardware configuration of the recommendation server 10 according to one example of the preferred embodiment of the present invention.

### PREFERRED MODE FOR CARRYING OUT THE INVENTION

An embodiment of the present invention will be hereinafter described with reference to the drawings.

### [System Configuration]

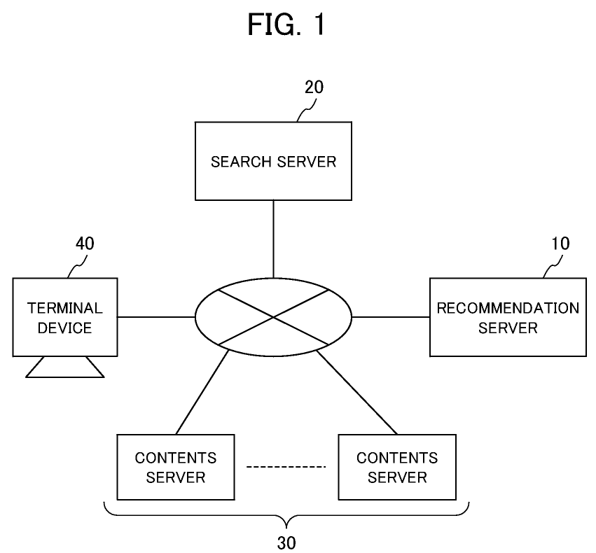

FIG. 1 is a block diagram which shows a search system according to one example of a preferred embodiment of the present invention.

A recommendation server 10, a search server 20, a contents server 30 and a terminal device 40 are connected to one another via a network. A user of the terminal device 40 accesses the search server 20 and inputs a query (keywords) for reaching a desired Web page to a predetermined search engine, thereby obtaining a search result. The user selects a URL listed on this search result, and browses a Web page managed by the contents server 30.

The recommendation server 10 stores, for the query input to the search engine of the search server 20, historical data (click data) of the URL and the like which the user browsed based on the search result. The recommendation server 10 determines a recommended query or URL as recommendation information which is newly recommended regarding the input query, the determination being made by means of a score for indicating the degree of popularity based on the historical data, and transmits the result to the terminal device 40. The user of the terminal device 40 performs a new search by means of the recommended query, which is different from the query input by the user himself/herself, or accesses the recommended URL, thereby reaching a desired Web page.

In this case, in order to determine recommendation information, the recommendation server 10 previously generates and stores graph data which links the query and the URL, and calculates a score for evaluating the degree of popularity of the query and the URL included in this graph data. Subsequently, the recommendation server 10 receives a new query from the terminal device 40, and determines, based on the previously calculated score, a query or URL to be recommended. The details of these processes will be described below.

It should be noted that though the recommendation server 10 is described as a single server, it is not limited thereto, but recommendation servers may be distributed as a plurality of servers corresponding to various functions to be described later.

### [Functional Block]

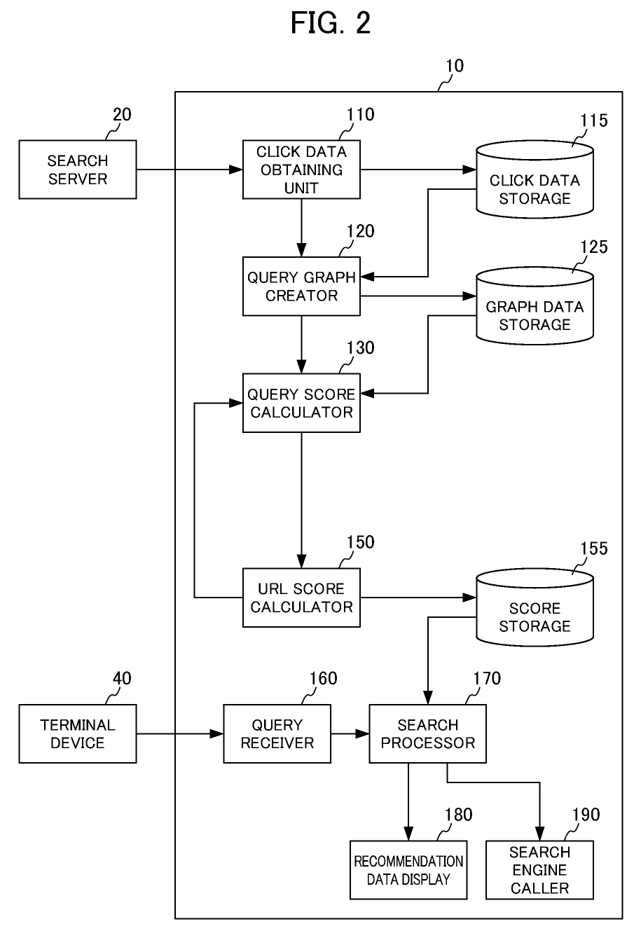

FIG. 2 is a block diagram which shows a functional configuration of the recommendation server 10 according to one example of the preferred embodiment of the present invention.

The recommendation server 10 is provided with a click data obtaining unit 110, a click data storage 115, a graph creator 120, a graph data storage 125, a query score calculator 130, a synonymous query extractor 140, a URL score calculator 150, a score storage 155, a query receiver 160, a search processor 170, a recommendation data display 180 and a search engine caller 190.

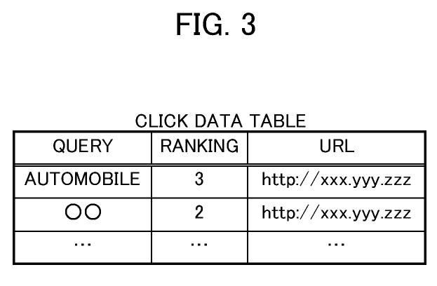

The click data obtaining unit 110 obtains click data from the search server 20 which is subsequently stored as historical data in the click data storage. The click data are accumulatively stored, for example, as a click data table shown in FIG. 3, and consist of at least queries, ranking and URLs.

The query included in the click data is a character string which the user of the terminal device 40 has input to a search engine provided to the search server 20. Moreover, the URLs in the click data show URLs which the user has clicked in the URL list obtained as a result of a search by the search engine. In addition, the ranking shows ranking of the URL clicked in the list of the search result, and corresponds to, for example, ranking from the top of the list of the search result.

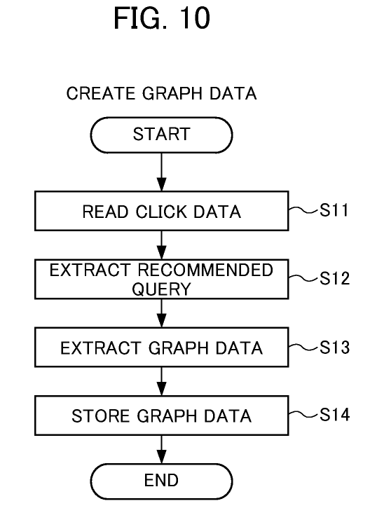

The graph creator 120 reads the click data stored in the click data storage 115, creates graph data which are subsequently stored in the graph data storage 125. It should be noted that the details of the process of creating the graph data will be describe later (FIG. 10.)

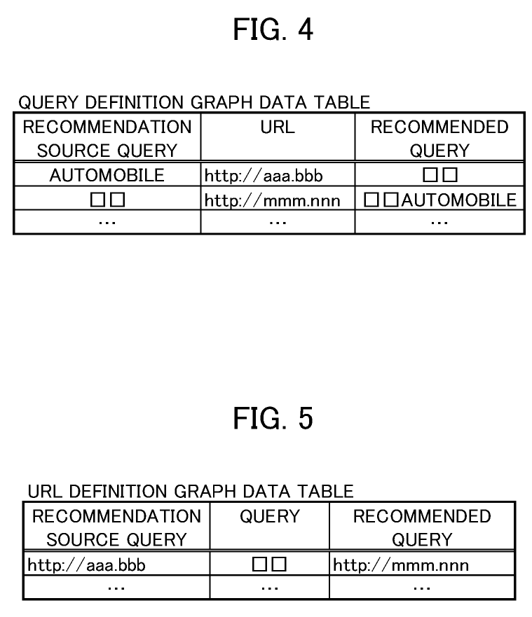

The created graph data are stored as, for example, a graph definition data table shown in FIG. 4 or a URL definition graph data table shown in FIG. 5. In FIG. 4, the graph data includes a first query and a second query, the second query being a recommended query based on the first query (recommendation source query), and a URL, which is stored with and can be searched from both the first and second queries. Since the search by the recommended query results in a URL which is associated with both the recommendation source query and the recommended query, the ranking of the URL in this case is higher than the case where a search is performed by the recommendation source query only.

Furthermore, in the query definition graph data table in FIG. 4, the second query [symbol] in the first row is the same as, and associated with, the first query in the second row. By this, the URL definition graph data table in FIG. 5 is created, the table storing the graph data in which the first URL (recommendation source URL) and the second URL (recommended URL) are associated with each other.

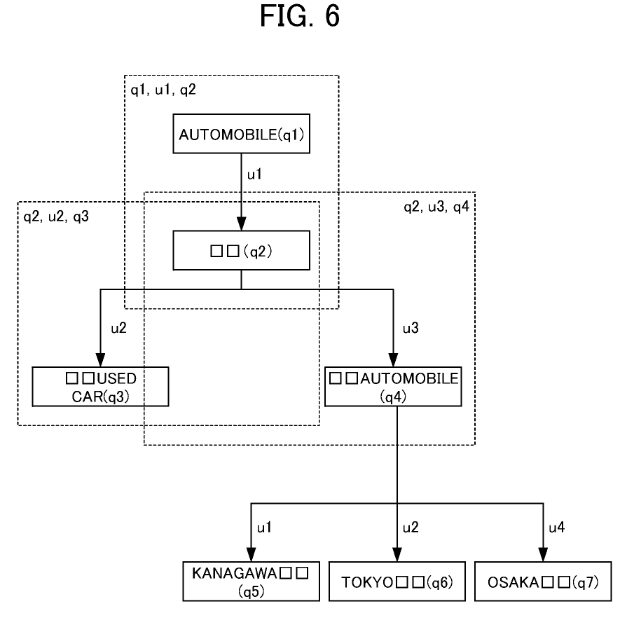

In this case, a set of query definition graph data shown in FIG. 4 constitutes a query definition graph structure as shown in FIG. 6, in which the recommendation source query (e.g. q1) is linked with the recommended query (q2) via a URL (u1) which can be search from both of the queries.

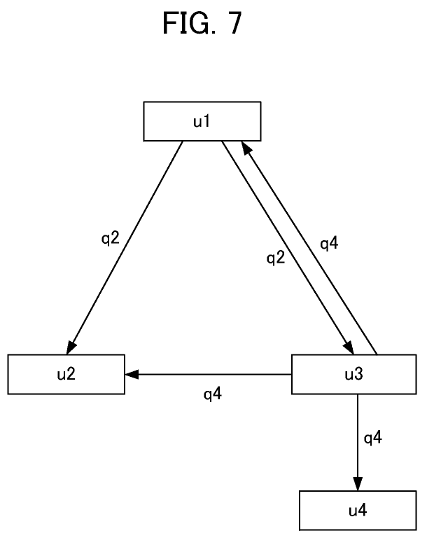

Moreover, a set of URL definition graph data shown in FIG. 5 constitutes a URL definition graph structure as shown in FIG. 7, in which a URL (u1) to be searched by a recommended query (e.g. q4) is linked with a URL (u2) to be searched by a further recommended query via the recommended query (q2).

It should be noted that a graph structure as shown in FIG. 6 in which queries are nodes is referred to as a “query definition” graph, and a graph structure as shown in FIG. 7 in which URLs are nodes is referred to as a “URL definition” graph. These two types of graph structures are not limited to a tree type as shown in FIG. 6, but can take a structure where links are looped as in the hyperlink structures on the Internet in many cases.

The query score calculator 130 obtains a query definition graph data (FIG. 4) from the graph data storage 125, and calculates a score (query score) for indicating the degree of popularity for each score. As scores to be calculated, a Page Rank (registered trademark) score, an authority score using HITS (Hypertext Induced Topic Selection) algorithm and a hub score are employed by means of existing techniques for analyzing hyperlink structures on the Internet. These techniques calculate a score of a node based on an input/output relationship of edges in a graph structure. According to a graph definition of a query definition, a score as a query is calculated based on an input/output relationship of a URL as an edge. It should be noted that other scores may be used as long as their techniques calculate a node score in a graph structure.

The URL score calculator 150 obtains a URL definition graph data (FIG. 5) from the graph data storage 125, and calculates a score (URL score) for indicating the degree of popularity of each URL. A calculation method in this case is the same as that for a query score, and a score of a URL as a node is calculated based on the input/output relationship of a query as an edge, according to a graph definition of a URL definition. In this case, a score calculated by the query score calculator 130 is input as an initial parameter for analysis.

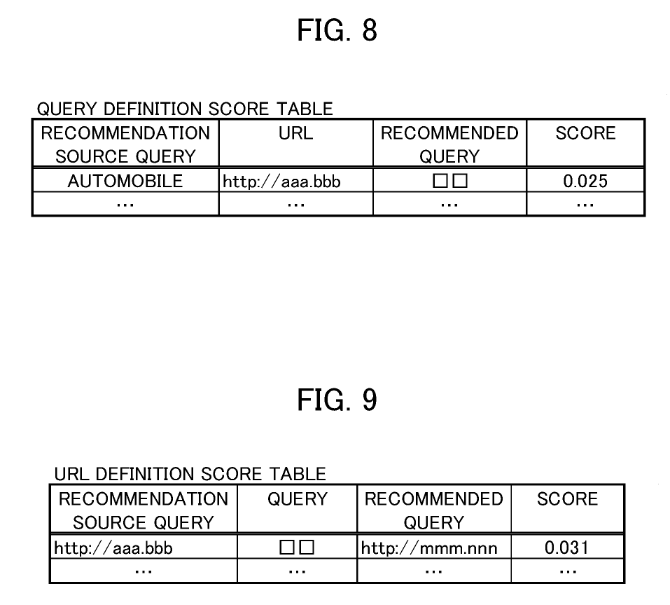

The URL score thus calculated is further input as an initial parameter of the query score calculator 130, and the recommendation server 10 repeats calculation of a query score and a URL score. As a result, query scores and URL scores converge, and the converged values are stored as, for example, a query definition score table shown in FIG. 8 and a URL definition score table shown in FIG. 9, in the score storage 155. In FIG. 8, scores for the second queries (recommended queries) are stored. In FIG. 9, scores for the second URLs (recommended URLs) are stored.

The query receiver 160 newly receives a query for a search from the terminal device 40, which is subsequently sent to the search processor 170.

The search processor 170 makes reference to the score storage 155 for the query received from the query receiver 160, and searches the query or URL as recommendation information, based on the stored scores.

The recommendation data display 180 transmits, to the terminal device 40, the query or URL as recommendation information searched by the search processor 170, which is subsequently displayed as a search result. The user of the terminal device 40 is able to perform further searches and to browse recommended URLs based on the displayed recommendation information.

In cases where recommendation information has not been searched by the search processor 170, the search engine caller 190 calls the search engine of the search server 20 or other search engines, and performs a URL search by means of conventional techniques based on the query received by the query receiver 160. This enables the recommendation server 10 to provide the user with a search result even in cases where recommendation information cannot be output.

### [Graph Data Creating Process]

FIG. 10 is a flow chart of a process of creating graph data according to one example of the preferred embodiment of the present invention.

At Step S11, the graph creator 120 reads click data from the click data storage 115.

At Step S12, the graph creator 120 extracts a recommended query (i.e. a query which makes it easier to reach each URL) based on the read click data.

Specifically, the graph creator 120 collects records, which retain the same URL, from the click data, and sorts the records in a descending order of evaluation values based on ranking or click frequency. The evaluation values are calculated, for example, as “log (click frequency)/ranking.” This calculation formula results in a high evaluation value in cases where the click frequency is high and the ranking is high (the ranking value is small). This makes it possible to determine that a query in higher ranking in the sorted records makes it easier to reach a predetermined URL as compared to queries in lower ranking. Accordingly, the query in high ranking or in the vicinity thereof is extracted as a recommended query against the queries in lower ranking.

It should be noted that the click frequency may be the number of times the user has clicked the URL in the search result, however it is not limited thereto, but the click frequency may be a proportion of the number of clicks to the number of searches (sessions) by the same query.

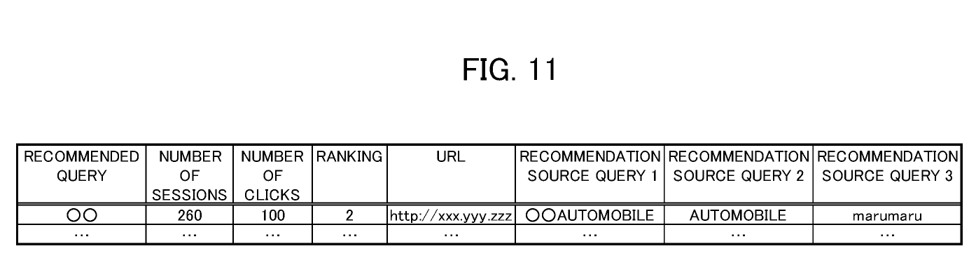

FIG. 11 is a table which shows a relationship between the extracted recommended query and the recommendation source queries which trigger the recommendation of the recommended query. In FIG. 11, the same URL is searched by the recommended query and the recommendation source queries, but the query which has the highest evaluation value based on the click frequency (the number of clicks/sessions) and the ranking is the recommended query. In cases where any one of the first to third queries is input as a query, the corresponding recommended query is a candidate for recommendation information.

At Step S13, the graph creator 120 extracts graph data based on the extracted recommended query.

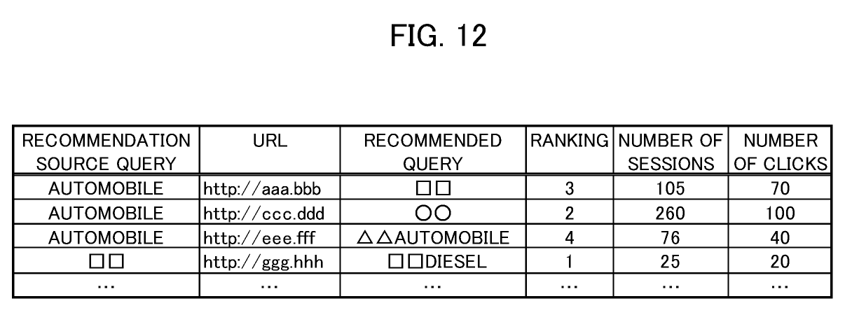

Specifically, according to the corresponding relationship shown in FIG. 11, a combination of recommendation source queries, URL and a recommended query is extracted as graph data. FIG. 12 is a table which shows combinations of the extracted graph data. Recommendation source queries and recommended queries are stored. A recommendation source query and a recommended query are associated with each other via a URL which can be searched by either.

It should be noted that the extracted combination may be one which has an evaluation value higher than a predetermined value based on the aforementioned ranking or click frequency, however it is not limited thereto, but may be a combination in which the evaluation value causes extraction of a predetermined number of top hits for the same recommendation source query.

At Step S14, the graph creator 120 stores the extracted graph data in the graph data storage 125. Specifically, as mentioned above, the query definition graph data and the URL definition graph data are stored as tables shown in FIG. 4 and FIG. 5, respectively. It should be noted that each of the tables may include the ranking, the number of sessions and the number of clicks as shown in FIG. 12, and may include the aforementioned evaluation values based on these.

### [Score Date Creating Process]

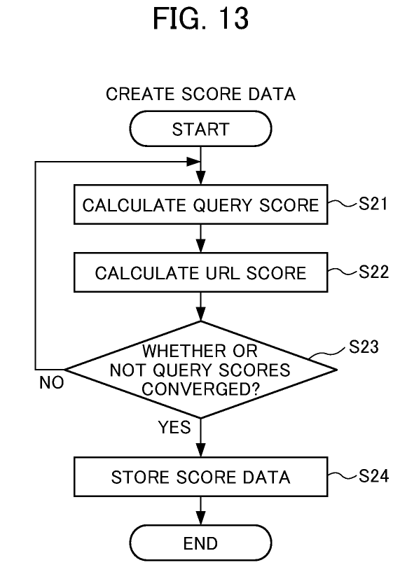

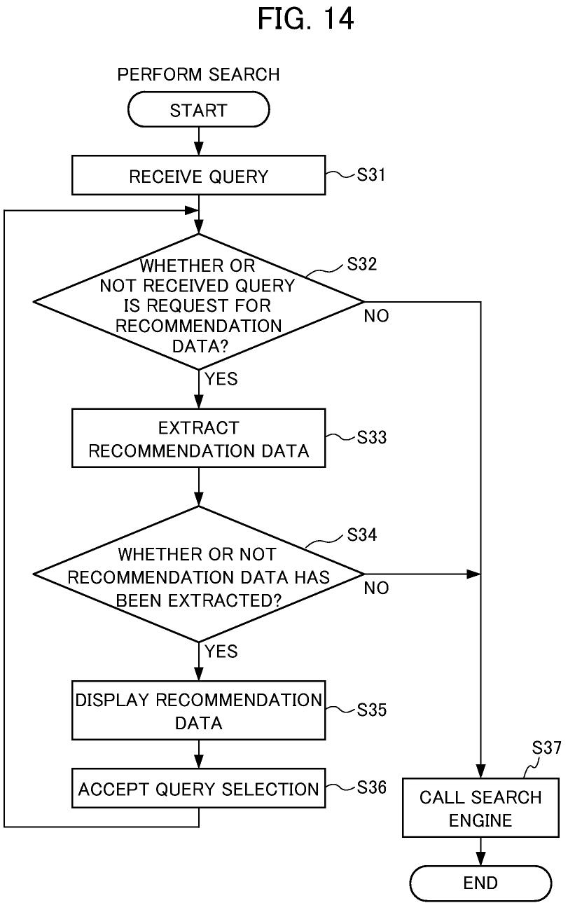

FIG. 13 is a flow chart which shows a process of creating score data according to one example of the preferred embodiment of the present invention.

At Step S21, the query score calculator 130 calculates a score for indicating the degree of popularity of each query, based on the query definition graph data stored in the graph data storage 125. Though this score can be calculated by means of various techniques (e.g., PageRank (trademark) and HITS), weighting is performed to the connection between a query and a URL, in which the degree of popularity of the URL in the search by the query is reflected. Furthermore, a bias relating the ranking of the URL presented to the user can be imparted by this weighting. In other words, since the users rarely click URLs displayed in lower ranking in the search result, a greater weighting may be performed on the lower ranking.

At Step S22, the URL score calculator 150 calculates a score for indicating the degree of popularity of each URL by applying an analysis technique for hyperlink structures to the graph relationship of the URL definition graph data stored in the graph data storage 125. In this case, the query score calculated at Step S21 is used as an initial parameter for calculation.

Subsequently, the URL score calculated at Step S22 is input as an initial parameter of Step S21, and Steps S21 to S22 are repeated. As a result, the query scores and the URL scores converge to a certain value.

Now, at the Step S23, it is determined whether or not the query scores and the URL scores respectively calculated at Steps S21 and S22 converged to a certain value. In cases where it is determined that the scores have converged (it is determined as YES), the calculating steps terminate and the process proceeds to Step S24. In cases where it is determined that the scores have not yet converged (it is determined as NO), the process returns to Step S21 and repeats the calculation of scores.

At Step S24, the score storage 155 stores the query score and the URL score which are determined to have converged at Step S23.

### [Search Performance Process]

FIG. 14 is a flow chart which shows a process of performing searches according to one example of the preferred embodiment of the present invention.

At Step S31, the query receiver 160 receives a new query for searching from the terminal device 40, and the search processor 170 performs a search process based on the query.

At Step S32, the search processor 170 determines whether or not the request from the terminal device accompanying the query is a search of a recommended query or a recommended URL as recommendation data. In cases where it is determined as YES, the process proceeds to Step S33 because a search of the recommendation data has been requested. On the other hand, in cases where it is determined as NO, the process proceeds to Step S37 because a search of a URL associated with the received query is requested, instead of a search of the recommendation data.

At Step S33, the search processor 170 extracts a recommended query or a recommended URL as recommendation data based on the received query. At this time, the search processor 170 may evaluate the recommendation data based on the score stored in the score storage 155, and extract recommendation data with a high score. Examples of recommendation data to be extracted are shown in (1) to (7) as follows.

(1) In the query definition graph data (FIG. 4), a recommended query corresponding to a recommendation source query that is the same as the received query is extracted as recommendation data. At this time, ranking is performed based on the score of the recommended query. As a result, the recommendation server 10 reaches a URL desired by the user regarding the received query. Accordingly, it is possible to recommend the user a query of a subordinate concept, with which the URL can be searched as a search result high in ranking.

(2) In the query definition graph data (FIG. 4), a recommendation source query corresponding to a recommended query that is the same as the received query is extracted as recommendation data. At this time, ranking is performed based on the score of the recommendation source query. As a result, the recommendation server 10 reaches a URL desired by the user regarding the received query. Accordingly, it is possible to recommend the user a query of a superordinate concept, with which the URL can be searched as a search result.

(3) A query of a node positioned in a vicinity of a node of the received query in the graph data is extracted as recommendation data. In this case, the “vicinity” indicates, for example, queries on up to two nodes removed, via URLs which serve as edges in the graph data, from the node. As a result, there is a possibility that the recommendation server 10 can recommend a query which is highly associated with the received query.

(4) In the query definition graph data (FIG. 4), a recommended query corresponding to a recommendation source query that is the same as the received query is extracted, and a query positioned in the vicinity of the recommended query in the graph structure is extracted as recommendation data. As a result, there is a possibility that the recommendation server 10 can recommend a query associated with a subordinate concept of the received query.

(5) In the query definition graph data (FIG. 4), a recommendation source query corresponding to a recommended query that is the same as the received query is extracted, and a query positioned in the vicinity of the recommendation source query in the graph structure is extracted as recommendation data. As a result, there is a possibility that the recommendation server 10 can recommend a query associated with a superordinate concept of the received query.

(6) In the query definition graph data or the URL definition graph data, a URL positioned in the vicinity of the received query is extracted as recommendation data. As a result, there is a possibility that the recommendation server 10 can recommend a URL which is associated with the received query, and which has a high degree of popularity.

(7) In association with the queries recommended by the techniques (1) to (5), a URL which is associated with the queries (a URL as a basis of the recommended queries) is extracted as recommendation data. As a result, there is a possibility that the recommendation server 10 can present a URL which has a high degree of popularity together with the recommended queries.

In the aforementioned techniques for extracting recommended queries, regarding the matching of the received query and the graph data, it is preferable that the character strings completely match each other, but it is not limited thereto. For example, determination may be made based on the matching of partial character strings broken down by a morphological analysis, or on the degree of similarity measured by an edit distance of the character strings.

Moreover, evaluation of the recommendation data based on the score may be the score itself stored in the score storage 155, but it is not limited thereto. For example, in order to obtain a relative evaluation for the received query (base point), a weighted average may be calculated as an evaluation value by adding, as elements, a distance from the base point, a click frequency of URL and the like.

If it is set that a longer distance from the base point results in a lower evaluation value, a query or URL which is closer to (i.e. more highly associated with) the received query is extracted with higher priority. Moreover, if it is set that a higher click frequency results in a higher evaluation value, there is a possibility that recommendation data with a higher degree of popularity is prioritized.

In addition, a query having a score close to the score of the received query (i.e. a query having a score within a predetermined range) may be extracted with higher priority. As a result, there is a possibility that recommendation data with contents closer to those regarding the received query is presented with higher priority, thereby making it possible to efficiently search information associated with the received query.

After attempting extraction of the recommendation data at Step S33 as described above, the search processor 170 determines, at Step 34, whether or not the recommendation data has been successfully extracted. In cases where it is determined as YES, the process proceeds to Step S35 because the recommendation data has been successfully extracted. In cases where it is determined as NO, the process proceeds to Step S37 because there is no recommendation data.

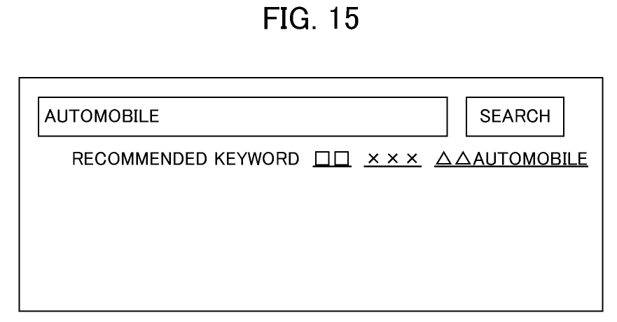

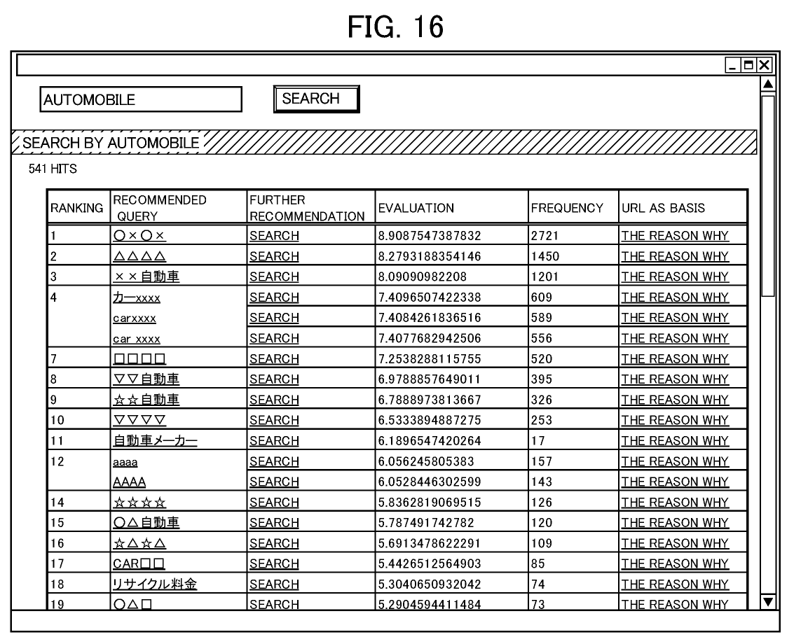

At Step S35, the recommendation data display 180 transmits the recommendation data extracted at Step 33 to the terminal device 40 and is displayed thereon. FIGS. 15 and 16 are diagrams which show examples of a display screen on which the recommendation data is displayed.

In FIG. 15, as a first example, a recommended query is displayed as “recommended keywords” in relation to a query “automobile” input by the user.

In FIG. 16, as a second example, recommended queries with ranking are displayed in relation to the query “automobile” input by the user. Moreover, for each of the displayed recommended queries, a URL as a basis of the recommendation (a URL associated with the recommended query) is displayed together. In addition, in FIG. 16, evaluation values based on scores of the recommended queries as well as click frequencies of URLs are also displayed.

Furthermore, the recommended queries having scores close to one another are grouped and displayed as synonymous queries. In this case, as for the synonymous queries, only one query representative of the group of the synonymous queries may be displayed, thereby making it possible to suppress the number of displayed items to enhance visibility for the user.

At Step S36, the query receiver 160 accepts a query selection, from the displayed recommendation data, as a further search request, and the process returns to Step S32. Specifically, for example, in FIG. 16, if an item under “recommended query” is clicked, a search request for its associated URLs is accepted. Moreover, if an item under “further recommendation” for the recommended query is clicked, a search request for recommendation data is accepted in which the recommended query is a recommendation source query.

At Step S37, the search engine caller 190 calls a conventional search engine such as the search engine of the search server 20, and searches URLs associated with the query. This makes it possible to search URLs based on the recommendation data displayed as recommendation data by the recommendation server 10.

### [Hardware Configuration of Server]

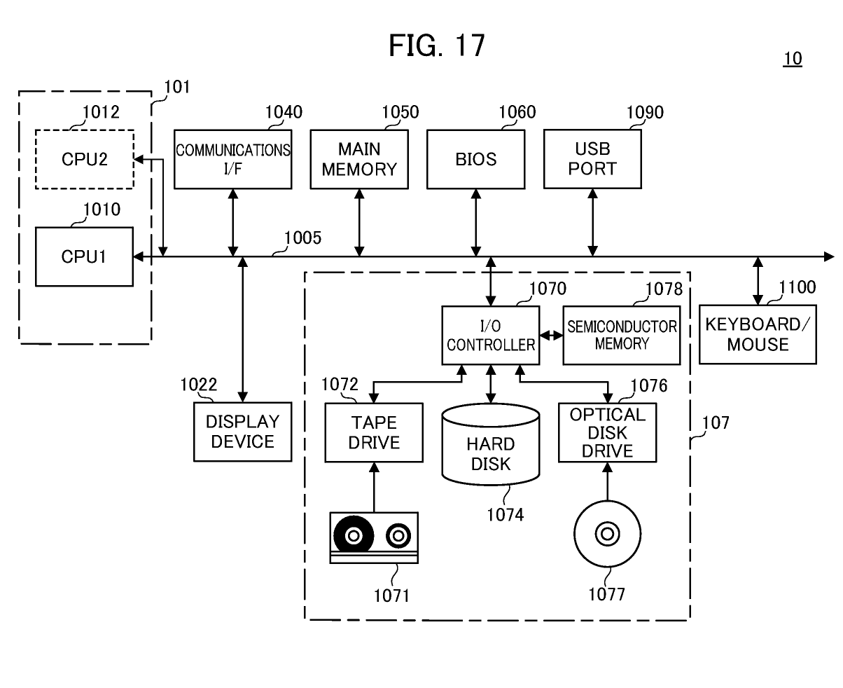

FIG. 17 is a diagram which shows an example of a hardware configuration of the recommendation server 10 according to an example of preferred embodiments of the present invention. The recommendation server 10 is provided with a CPU (Central Processing Unit) 1010 (a plurality of CPUs such as a CPU 1012 may be added thereto in a multiprocessor configuration) which constitutes a controller 101 which implements each function in FIG. 2; a bus line 1005; a communications I/F 1040; a main memory 1050; a BIOS (Basic Input Output System) 1060; a USB port 1090; an I/O controller 1070; input means such as a keyboard and a mouse 1100; and a display device 1022.

The I/O controller 1070 can be connected with storage means such as a tape drive 1070, a hard disk 1070, an optical disk drive 1076 and a semiconductor memory 1078.

The BIOS 1060 stores a boot program executed by the CPU 1010 at the time of starting up the recommendation server 10, programs dependent upon the hardware of the recommendation server 10 and the like.

The hard disk 1070, which constitutes a storage 107, stores various programs for causing the recommendation server 10 to function as a server, and stores programs for implementing functions of the present invention. Furthermore, the hard disk 1070 is able to configure various databases depending on the necessity (e.g. the click data storage 115, the graph data storage 125, the score storage 155 and the like).

As the optical disk drive 1076, it is possible to use, for example, a DVD-ROM drive, a CD-ROM drive, a DVD-RAM drive and a CD-RAM drive. In this case, an optical disk 1077 compatible with each drive is used. It is also possible to read a program or data from the optical disk 1077 via the optical disk drive 1076, and provide the program or data to the main memory 1050 or the hard disk 1074 via the I/O controller 1070.

A program to be provided to the recommendation server 10 is provided in a way that it is stored in a storage medium such as the hard disk 1074, the optical disk 1077 or a memory card. This program may be read from the storage medium via the I/O controller 1070, or downloaded via the communications I/F 1040, and installed in the recommendation server 10 for execution.

The aforementioned program may be stored in an internal or external storage medium. As a storage medium which constitutes the storage 107, it is possible to use the hard disk 1074, the optical disk 1077, the memory card, as well as a magnetic-optical storage medium such as an MD and a tape medium. Moreover, a storage device such as the hard disk drive 1074 or an optical disk library provided to a server system connected to a dedicated communications line or the Internet may be used to provide the program to the recommendation server 10 via a communications line.

In this case, the display device 1022 is for displaying a screen for accepting data input by the user, and for displaying a screen of a calculation result by the recommendation server 10, and includes display devices such as a cathode-ray tube display (CRT) or a liquid crystal display (LCD).

In this case, the input means is for accepting inputs from the user, and may be configured with the keyboard and mouse 1100 and the like.

Moreover, the communications I/F 1040 is a network adapter for enabling the recommendation server 10 to connect with terminals via a dedicated network or a public network. The communications I/F 1040 may include a modem, a cable modem and an Ethernet (registered trademark) adapter.

Although the above example has been described mainly about the recommendation server 10, it is also possible to achieve the aforementioned functions by installing the program in a computer to cause the computer to function as a server device. Accordingly, the functions achieved by the recommendation server 10 as has been described as one embodiment of the present invention can also be achieved by executing the aforementioned processes by the computer, or installing the aforementioned program in the computer for execution.

### [Hardware Configuration of Terminal Device]

The terminal device 40 also has a configuration similar to that of the aforementioned recommendation server 10. Although the aforementioned example has been described as implementing by a so-called computer, various terminals such as a mobile phone, a PDA (Personal Data Assistant) or a game device may be used for such implementation.

Although the embodiment of the present invention has been described above, the present invention is not limited to the aforementioned embodiment. The effects described in the embodiment of the present invention are merely enumeration of the most preferable effects arising from the present invention, and the effects of the present invention is not limited to those described in the embodiment of the present invention.

What is claimed is:

1. A method for calculating a score for a query that is input by a user to a search engine, the method comprising the steps of:
storing historical data including a query log and click-through data, the query log including a keyword as the query, a URL as a search result by the search engine, and ranking of the URL, and the click-through data being related to the URL;
analyzing the historical data for generating a graph structure of a query definition, wherein the query is a node and a plurality of nodes are connected by URLs that are common to the plurality of nodes, the URLs being browsed based on the search result corresponding to the query of the node;
extracting, from the graph structure, combinations of recommendation source queries and recommended queries which are connected by URLs;
calculating a score for the combinations extracted in the extracting step, based on the click-through data and ranking data; and
associating at least one combination extracted in the extracting step with one recommendation source query.

2. The method according to claim 1, further comprising the steps of:
identifying the recommendation source query by receiving an input query; and
outputting, in response to receiving the input query, at least one recommendation source query from combinations extracted by association with the input query.

3. A method for calculating a score for a query that is input by a user to a search engine in a server that is connected, via a network, to a terminal device and a search server provided with the predetermined search engine, the method comprising the steps of:
storing, as historical data, a query input to the search engine from the terminal device, a URL browsed based on a search result of the search engine in response to the input of the query, and ranking of the URL browsed in the search result, so as to be associated with one another;
extracting, based on the stored historical data, combinations including recommendation source queries, URLs and recommended queries, wherein, among a plurality of queries associated with the same URL, each respective query having an evaluation value high in ranking is included in the recommended queries, and wherein queries other than the recommended queries are the recommendation source queries; and
calculating a score for each query input by the user, by analyzing a relationship between input and output of edges in a graph structure which is configured by a set of the extracted combinations, and in which a plurality of queries are connected via URLs, wherein each query is a node of the graph structure.

4. A method for calculating a score for a URL associated with a query that is input by a user to a search engine in a server that is connected, via a network, to a terminal device and a search server provided with the search engine, the method comprising the steps of:
storing, as historical data, a query input to the search engine from the terminal device, a URL browsed based on a search result of the search engine in response to the input of the query, and ranking of the URL browsed in the search result, so as to be associated with one another;
extracting, based on the stored historical data, combinations including recommendation source queries, URLs and recommended queries, wherein, among a plurality of queries associated with the same URL, each respective query having an evaluation value high in ranking is included in the recommended queries, and wherein queries other than the recommended queries are the recommendation source queries; and
calculating a score for each of the URLs, by analyzing a relationship between input and output of edges in a graph structure which is configured by a set of the extracted combinations, and in which a plurality of URLs are connected via queries, wherein each URL is a node of the graph structure.

5. The method according to claim 3, further comprising a first transmitting step, wherein, in response to a newly input query from the terminal device, a query associated with the newly input query is extracted as recommendation information based on the graph structure and the score, and is transmitted to the terminal device.

6. The method according to claim 4, further comprising a first transmitting step, wherein, in response to a newly input query from the terminal device, a URL associated with the newly input query is extracted as recommendation information based on the graph structure and the score, and is transmitted to the terminal device.

7. The method according to claim 5, wherein the first transmitting step extracts queries having scores within a predetermined range of values in relation to the newly input query, the extracted queries being high in ranking.

8. The method according to claim 5, wherein the first transmitting step groups and extracts, from the recommendation information, recommendation information having a score within a predetermined range of values.

9. The method according to claim 5, wherein the first transmitting step calculates, based on the score, an evaluation value for each of the recommendation information in relation to the newly input query, and extracts recommendation information excluding recommendation information having an evaluation value below a predetermined value.

10. The method according to claim 5, further comprising a second transmitting step of transmitting a search result of the search engine based on the newly input query in cases where the recommendation information is not extracted at the first transmitting step.

11. The method of claim 5, wherein the first transmitting step selects, from the graph structure, a query having a similarity to the newly input query exceeding a predetermined degree, and extracts the recommendation information with the selected query being a base point.

12. An apparatus for calculating a score for a query that is input by a user to a search engine, the apparatus being connected, via a network, to a terminal device and a search server provided with the predetermined search engine, the apparatus comprising:
storing means for storing, as historical data, a query input to the search engine from the terminal device, a URL browsed based on a search result of the search engine in response to the input of the query, and ranking of the URL browsed in the search result, so as to be associated with one another;
extracting means for extracting, based on the stored historical data, combinations including recommendation source queries, URLs and recommended queries, wherein, among a plurality of queries associated with the same URL, each respective query having an evaluation value high in ranking is included in the recommended queries, and wherein queries other than the recommended queries are the recommendation source queries; and
calculating means for calculating a score for each query input by the user, by analyzing a relationship between input and output of edges in a graph structure which is configured by a set of the extracted combinations, and in which a plurality of queries are connected via URLs, wherein each query is a node of the graph structure.

13. An apparatus for calculating a score for a URL associated with a query that is input by a user to a search engine, the apparatus being connected, via a network, to a terminal device and a search server provided with the predetermined search engine, the apparatus comprising:
storing means for storing, as historical data, a query input to the search engine from the terminal device, a URL browsed based on a search result of the search engine in response to the input of the query, and ranking of the URL browsed in the search result, so as to be associated with one another;
extracting means for extracting, based on the stored historical data, combinations including recommendation source queries, URLs and recommended queries, wherein, among a plurality of queries associated with the same URL, each respective query having an evaluation value high in ranking is included in the recommended queries, and wherein queries other than the recommended queries are the recommendation source queries; and
calculating means for calculating a score for each of the URLs, by analyzing a relationship between input and output of edges in a graph structure which is configured by a set of the extracted combinations, and in which a plurality of URLs are connected via queries, wherein each URL is a node of the graph structure.
